(19) United States
(12) Patent Application Publication
(10) Pub. No.: US 2010/0178448 A1
(43) Pub. Date: Jul. 15, 2010

(54) BEAD PICTURE BASED ON IMAGE DATA AND MANUFACTURING METHOD THEREOF

(75) Inventor: Takeshi Nakajima, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NAC CO., LTD., Kita-ku, Tokyo (JP)

(21) Appl. No.: 12/305,798

(22) PCT Filed: Feb. 1, 2008
(86) PCT No.: PCT/JP2008/052074

§ 371 Date: Dec. 19, 2008

(51) Int. Cl. B44C 1/28; B32B 37/00; A47G 1/00; B44C 5/08

(52) U.S. Cl. 428/67; 156/307.1

(57) ABSTRACT

An image data of an original is recorded on a pixel unit to a computer and the recorded image data of the computer is applied with image processing to form a subtractive color image data of predetermined number of color of beads based on the size of a bead picture to be prepared and the size of a bead sphere to be used. The substractive color image data is digitalized to the color number on an image pixel unit, and the color number of the digitalized subtractive color image data is indicated on a color number arrangement table of a predetermined size corresponded to the original. A plurality of beads corresponding to the respective color numbers are arranged and supported in a picture frame based on the arrangement of the indicated color numbers thereby completing a bead picture. A transparent resin solution that cures at a normal temperature or at an elevated temperature is cast into the gap between bead groups arranged in the picture frame and the transparent resin in the gap between the beads is integrally cured with the inner surface of the front and rear transparent plates to be formed into a bead supporting and receiving portion.

### TECHNICAL FIELD

The present invention concerns a bead picture which is drawn by beads with limited number of colors as a material based on color image data such as from photographs and digital cameras which are put to image decomposition into several tens of thousands of colors.

### BACKGROUND ART

A picture manufactured from beads of a plurality of colors as a material (paint) exhibits an inherent beautiful appearance due to colorfulness and reflection light of beads as a decorative article.

Japanese Utility Model Registration No. 3079248 discloses a stained glass-like bead frame picture as a technique of manufacturing a picture of an optional pattern by using color beads in which a picture plate formed by bonding colored or transparent beads conforming to respective print colors to a transparent film printed with a picture comprising a plurality of colors and provided with adhesiveness on the surface is put between and fixed with transparent plates.

### DISCLOSURE OF THE INVENTION

### Subject to be Solved by the Invention

As described above, while a technique of manufacturing a color puzzle or stained glass by arranging beads of corresponding colors to a color printed surface has been known, an attempt of manufacturing a picture with colored beads by using an optical method based on complicate color images such as a color photograph has not yet been known so long as the applicant recognizes.

In a case of taking images such as a usual photograph or picture into a computer such as a personal computer, the image data is stored and preserved while being decomposed into colors of 60 tens of thousands or more, the number of colors of the beads is limited (the existent number of colors of beads is about 130 at present), and it is actually impossible to complete fine color beads of about 2.5 mm diameter and 2.5 mm width into a bead picture based on photographic image data.

A first object of the present invention is to provide a beautiful bead picture using beads within a range of existent number of colors as a material, based on images such as a photograph by repetition of simple manual operation.

By the way, in a case when it is intended to manufacture a large-sized bead picture, for example, as large as of No. 30 by using a plurality of bead units formed by supporting a plurality of linked beads to a guide rod such as a piano wire, since the bead unit supported on the guide rod is made longer, this breaks down the balance of arrangement due to the weight, tending to result in slack or distortion in the picture plane.

Accordingly, a second object of the present invention is to provide a bead picture not resulting in distortion or disturbance on the picture plane even in a larger size (No.) of the picture.

A third object of the invention is to provide a method of manufacturing the bead picture described above.

### Means for Solving the Subject

For attaining the first object described above, the bead picture of the invention is characterized by digitalizing image data of an original image recorded in a computer on a pixel unit to subtractive image data allotted to a predetermined number of colors of beads on the pixel unit, and arranging and supporting material beads of corresponding colors in a picture frame based on the indication of a digitalized color number arrangement of the subtractive color image data.

Preferably, for the bead picture described above, a plurality of beads each of an identical shape and having a through hole in the axial direction are used, constituting a bead group of color numbers corresponding to the signs of the color number arrangement table into a bead group unit supporting them being linked to a guide rod such as a piano wire, and arranging the plurality of bead group units in rows and columns in a picture frame member.

Further, the bead picture of the invention is characterized in that, both surface and rearface of a picture formed by arranging and supporting beads are sandwiched between transparent plates such as transparent acrylic resin plates, and one identical picture can be observed visually from both sides as symmetric pictures.

For attaining the second object, the present invention is characterized by disposing a rearface transparent plate in a picture frame, casting a transparent resin solution that cures at a normal temperature or at an elevated temperature in a gap between the bead group arranged on the surface of the rear transparent plate, superposing a surface transparent plate over the upper surface thereof, and forming a bead supporting and receiving portion bonded integrally with the front and rear transparent plates by curing the transparent resin cast between the front and rear transparent plates at a normal temperature or an elevated temperature.

For attaining the third object described above, the method of manufacturing the bead picture according to the invention is characterized by recording image data of an original image on a pixel unit to a computer, applying an image processing to the recorded image data of the computer into subtractive image data of a predetermined number of bead colors based on the size of the bead picture to be prepared and the size of bead spheres to be used, digitalizing the subtractive image data with a color number on the image pixel unit, indicating the color number of the digitalized subtractive image data on a color number arrangement table of a predetermined size corresponding to the original image, and arranging and supporting a plurality of beads corresponding to respective color numbers in a picture frame based on the arrangement of the indicated color numbers.

The bead group is preferably arranged by constituting the bead group based on the color arrangement table as a bead group unit by arranging beads being linked to a tough and strong guide rod such as a piano wire.

In a case of manufacturing a large-sized bead picture, it is preferred to arrange the plurality of beads on the surface of the rear transparent plate disposed in a picture frame, cast a transparent resin solution that cures at a normal temperature or at an elevated temperature into a gap between arranged beads on the bead picture plane, superpose a front transparent plate over the upper surface thereof, and apply heat to the surfaces of the front and rear transparent plates, and bond and cure the resin between the bead gap integrally to the surfaces of the front and rear transparent plates thereby carrying the beads.

### EFFECT OF THE INVENTION

According to the invention, by using colorful images such as a color photograph comprising several tens of thousands of colors as a subject, a beautiful picture optically corresponding to the photographic images can be obtained by repeating simple manual operations using beads of limited number of colors.

Since the transparent resin solution that cures at a normal temperature or at an elevated temperature is filled or cast and cured in the gap between the beads of the bead picture sandwiched at the front surface and the rearface with transparent acryl resin plates, the arranged bead group is supported by the cured resin integrally bonded to the inside of the front and rear transparent acryl resin plates, thereby not causing distortion, slack, disturbance, etc. to the bead surface of the picture plane.

### BRIEF EXPLANATION OF DRAWINGS

FIG. 1 shows an original image.

FIG. 2 is an enlarged view for an image data portion of the original image.

FIG. 3 is a subtractive color image.

FIG. 4 is an enlarged view for a portion of a color number arrangement table of subtractive color image data.

FIG. 5 is an enlarged front elevational view of a bead.

FIG. 6 is an enlarged side elevational view of a bead.

FIG. 7 is an enlarged view for a portion of the bead picture.

FIG. 8 is a front view of a bead picture.

FIG. 9 is an enlarged view for a portion of a bead group unit.

FIG. 10 is an enlarged cross sectional view along line A-A in FIG. 8.

FIG. 11 is a rearface view of the bead picture.

FIG. 12 is an enlarged transversal cross sectional view for a portion of a bead picture according to another embodiment of the invention.

### DESCRIPTION OF REFERENCES

1 original
2 image data
3 subtractive image data
4 digitalized color number
5 subtractive color number arrangement table
6 image pixel
7 bead
8 circular axial body
9 through hole
10 tapered surface
11 picture frame member
12 bead picture front face
12′ bead picture rear face
13 support rod
14 bead group unit
15 transparent plate
16 transparent plate
17 spacer
18 bead supporting and receiving portion

### BEST MODE FOR CARRYING OUT THE INVENTION

The present invention basically includes the following steps (a) to (f).

(a) Images of an original such as a photograph or picture is taken into a computer such as a personal computer by a scanner or the like and the image data is recorded on a pixel unit.
(b) A dimension (size) of a bead picture to be prepared is determined and set to the computer.
(c) The size of a material bead sphere to be used for the bead picture is set to the computer.
(d) Image data of an original recorded in the computer is allotted to a predetermined color number and replaced with a substractive image data based on the determined size value of the bead picture and the determined size value of the material bead.
(e) The subtractive image data is digitalized on an image pixel unit and indicated as a color number arrangement table corresponding to the number of colors of beads.
(f) A plurality of beads of corresponding color numbers are supported in a picture frame in accordance with the arrangement of the color number arrangement table to complete an aimed bead picture (picture).

Examples of the present invention are to be described with reference to appended drawings.

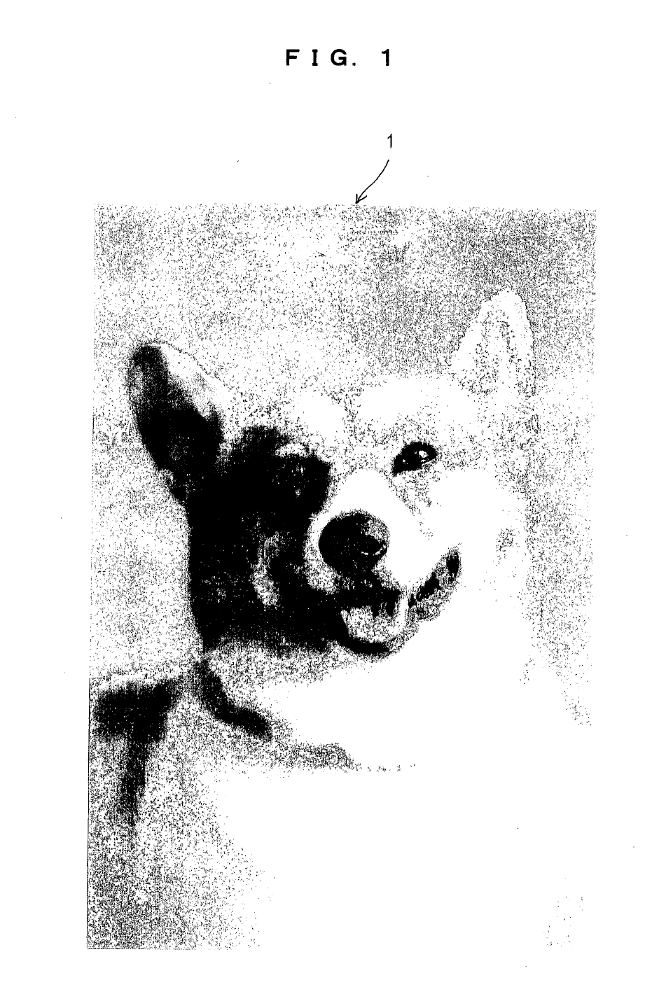

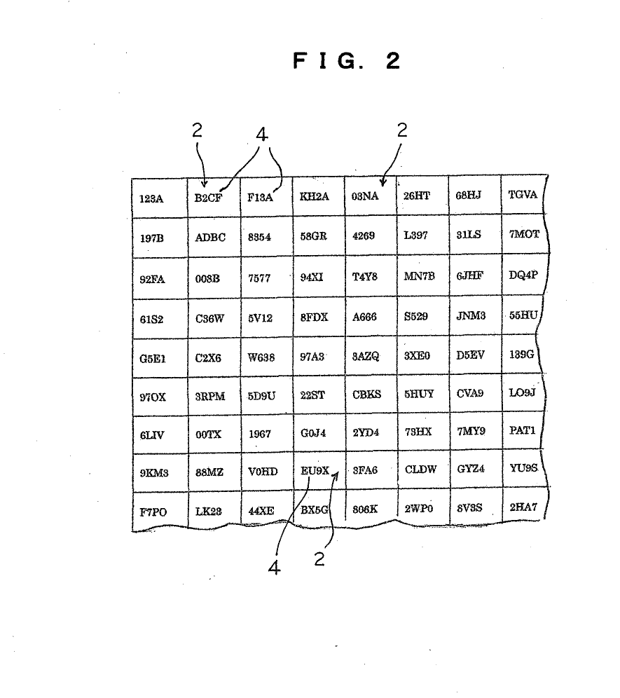

When an original image 1 of things, pictures, etc. in FIG. 1 (photograph of a dog's face) as a subject of the bead picture is taken into a computer such as a personal computer, the image data 2 is recorded being decomposed into pixel units as shown in FIG. 2 by a usual computer image processing.

Generally, since a color photograph of a picture, landscape, etc. is recorded being decomposed usually to sixty thousands or more of colors, it is impossible to arrange the beads of limited number of colors corresponding to the color data of the pixel units.

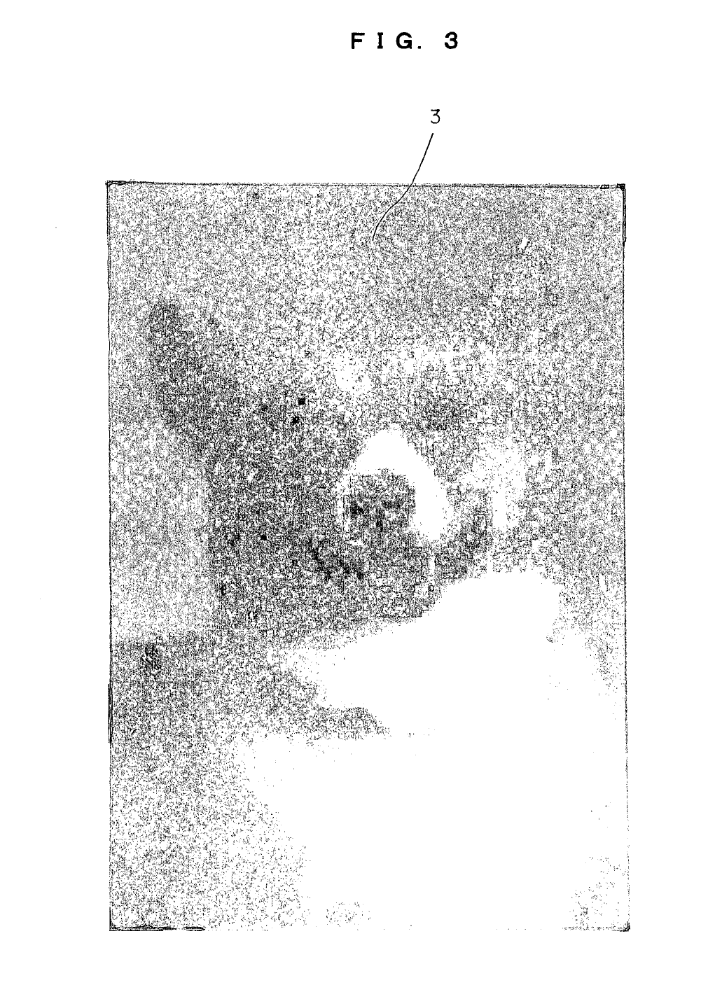

In view of the above, in the invention, the image data 2 for the original recorded in the computer is processed to a subtractive color image data 3 in FIG. 3 allotted to a predetermined number of colors of beads (subtractive image processing), and the subtractive color image data is digitalized and stored on an image pixel unit.

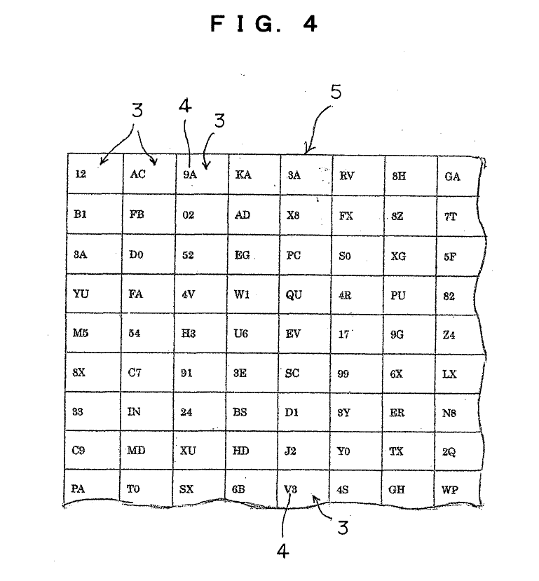

Then, as shown in FIG. 4, groups of digitalized color numbers 4 of the subtractive color image data 3 stored on the pixel unit are image-displayed on a monitor screen as a color number arrangement table 5 for the subtractive color image data corresponding to the original and optionally printed on the surface of paper.

The processing of allotting the image data 2 of the original recorded in the computer to a desired number of colors of beads, replacing them with the subtractive color image data 3 in FIG. 3, and digitalizing and displaying them on the pixel unit as the color number arrangement table 5 on the monitor can be practiced, for example, by the following steps.

(1) A photograph, digital camera images, down-loaded images, etc. are taken into a computer, for example, a personal computer (hereinafter referred to as a personal computer) by a scanner, a card reader or the like. The image data taken into the personal computer is digitalized and stored in BMP (bit map form).
(2) Then, based on the image data taken into the computer, the size of the beads to be used and the size of the bead picture to be manufactured are determined.

For example, in a case of manufacturing a bead picture of No. 30 (910 mm×652 mm) by using material beads each of 2.5 mm length×2.5 mm width, beads by the number of 910÷2.5=364 for columns and 652÷2.5=260 for rows, that is, 94,640 in total of beads are used.

(3) For manufacturing a bead picture of a determined size, images taken by an image processing software available commercially or prepared as a proprietary program is processed into 364 pixels in column (number) and 260 pixels in rows (number) on the pixel unit (the number of pixel=number of beads in this example). In this case, subtraction is conducted to a desired number of colors while optionally controlling the luminance, contrast, tone, etc. of images. In this case, a color subtractive pallet to be used is fixed, and a commercially available 256 color pallet, a 256 color pallet manufactured by Microsoft Co. or a pallet prepared by its own can be used as the pallet.

The subtracted color images are at first digitalized and stored in BMP (bit map form).

(4) The data file for the subtractive color images constituted by the method described above is prepared based on a pallet of 256 colors. Then, in a case where the number of colors of beads used actually is less than 256 colors, for example, in a case of setting to 130 colors, since it is necessary for further color subtraction, similar colors are replaced with a color corresponding to a color in a determined range while confirming with naked eyes to prepare a pallet of 130 colors of its own.
(5) Since the image data prepared in the BMP form as described above has already been digitalized, the images subtracted further from the BMP image file of 256 colors by the pallet of the 130 colors are also stored by the BMP form. In this case, a numerical value extraction software for BMP images may also be used.
(6) When actually processing the BMP file as data on the personal computer, since the data for 1 pixel (number) is difficult to be read in a case where the number of digits is large, the numerical value or symbol thereof is facilitated for reading by allotting to a decimal number on two digits. The converted file forms a TX text file and the conversion operation can be conducted by using a text substitution software.
(7) The completed text file is optionally processed into a size easy to see and printed. Further, printing may be conducted while optionally dividing into several sheets.

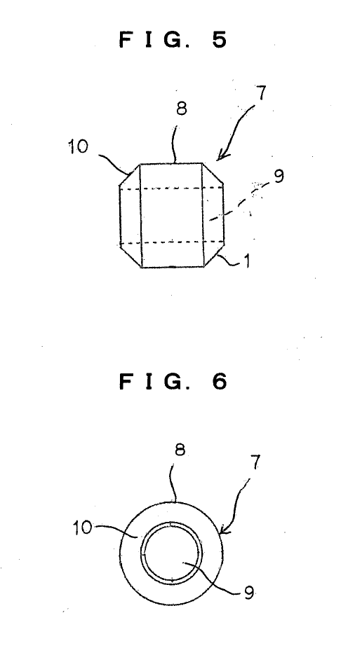

FIG. 5 and FIG. 6 show an example of a bead 7 used as a material for the bead picture of the invention. The bead 7 of this example comprises a bead sphere of a circular axial member 8 having a through hole 9 at the axial center and chamfered on both right and left sides of the circular axial member 8 to tapered faces 10. The original size is 2.5 mm in the diameter and 2.5 mm in the width, the through hole 9 has 1.4 mm diameter and the number of colors of the bead spheres is 130 colors at present.

In the illustrated example, a bead using aluminum as a material and colored with a color paint is used, but the material of the beads 7 is not restricted only thereto but other metals or synthetic resins can also be used. Further, also the shape, the structure, etc. of the bead 7 are not restricted to those of the example described above and others such as of cylindrical shape or spherical shape, etc. can also be used naturally so long as they are beads and they are also included in the invention.

It is naturally expected that the number of colors of bead will be further differentiated and increased in the colors.

The beads 7 are contained divisionally in pallets or other containers separated into respective colors.

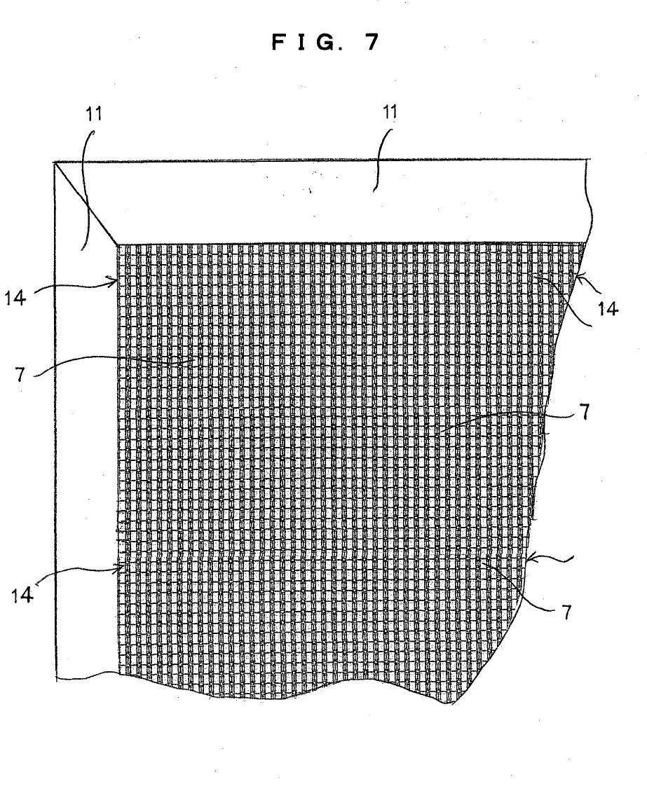

The manual operation for manufacturing the bead picture according to the invention is conducted, as shown in FIG. 7, by arranging the bead 7 of colors corresponding to respective digitalized color numbers 4 so as to be contained in a picture frame 11 in accordance with images of the color number arrangement table 5 in FIG. 4 displayed on the monitor of a personal computer, etc. or arrangement indicated on the print thereof.

Since the image data of the color number arrangement table 5 is arranged on the unit of the image pixel by the subtractive image processing based on the photographic original image data, when the group of the color beads 7 is arranged and supported in the frame member 11 in accordance with the color number arrangement order for the image data of the number arrangement table 5 subjected to subtractive color image processing based on the photographic original 1 in FIG. 1, a bead picture 12 which is subtracted corresponding to the original 1 is completed as shown in FIG. 7.

Upon manufacture of the bead picture, in accordance with the arrangement order for the rows or columns in the color number arrangement table 5 in FIG. 4, beads 7 of relevant colors are selected from a bead case (not illustrated in the drawing) corresponding to respective color numbers and they are arranged on a plate in the picture frame member 11.

In the actual operation, for easy arrangement and stable support of the group of beads 7, a group of beads 7 corresponding to each column of the color number arrangement table 5 are preferably fitted externally over a common support rod 13 by way of the through hole 9 of each of the beads 7 to form into a series of bead group unit 114, and both ends of the support rod 13 passing through the bead group unit 14 are engaged to the picture frame member 11 to form a picture plane successively.

For the support rod 13, a fine wire-like rod having rigidity, for example, a piano wire is used preferably.

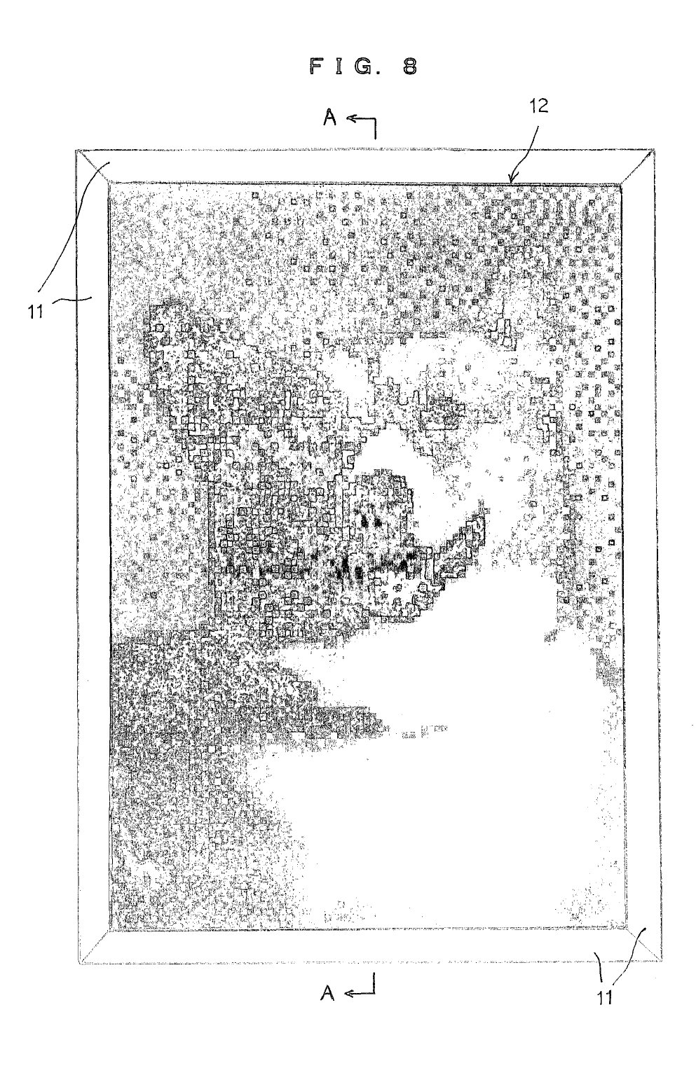

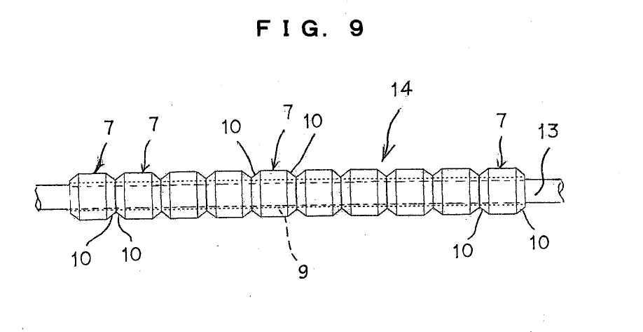

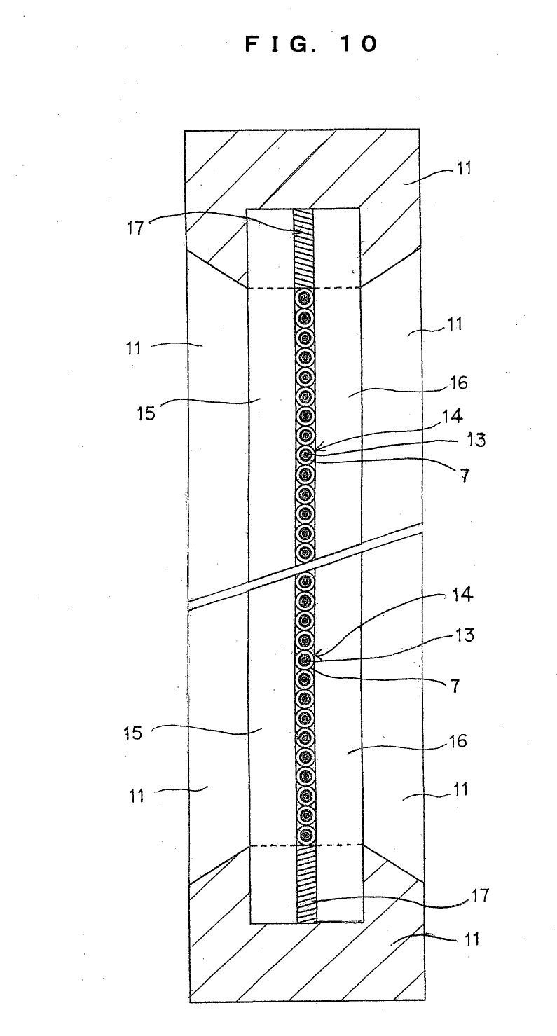

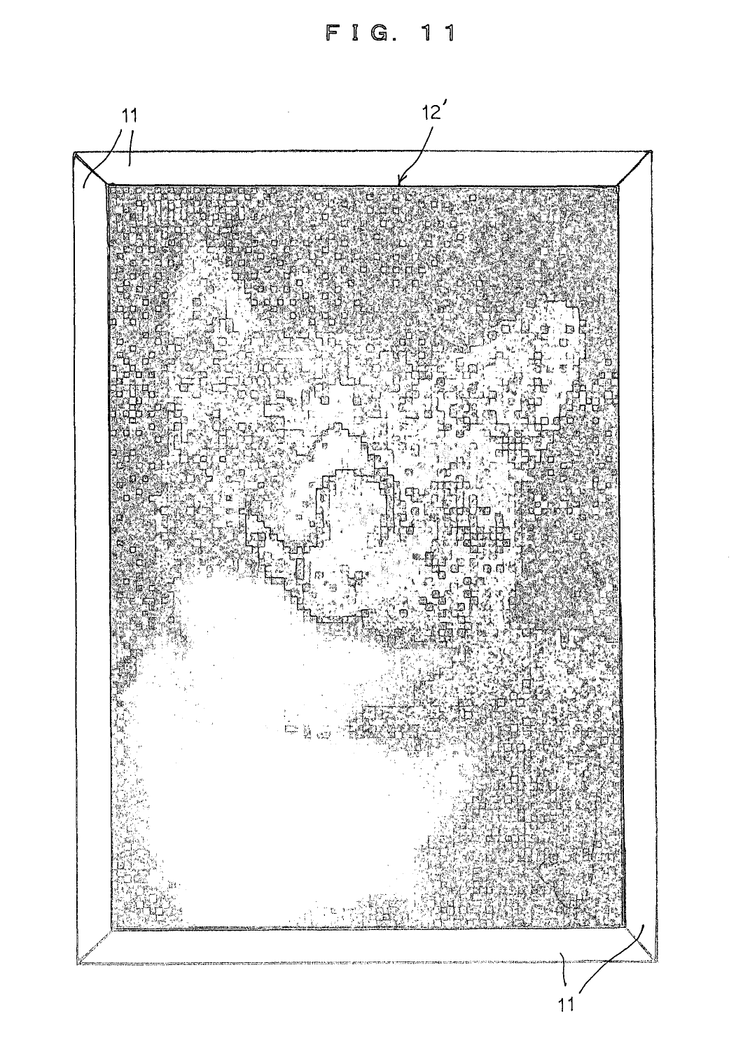

After arranging the groups of the beads 7 in accordance with all color numbers 4 in the color number arrangement table 5, the upper surface thereof is supported by a transparent plate 16 such as a transparent acrylic resin plate or glass, and the arranged groups of beads 7 are sandwiched between the transparent plates 15 and 16 and supported on the picture frame member 11, to complete the bead picture 12 shown in FIG. 8 and FIG. 10.

FIG. 10 is a vertical cross sectional view of the bead picture 12 shown in FIG. 8 and reference 17 shows a spacer.

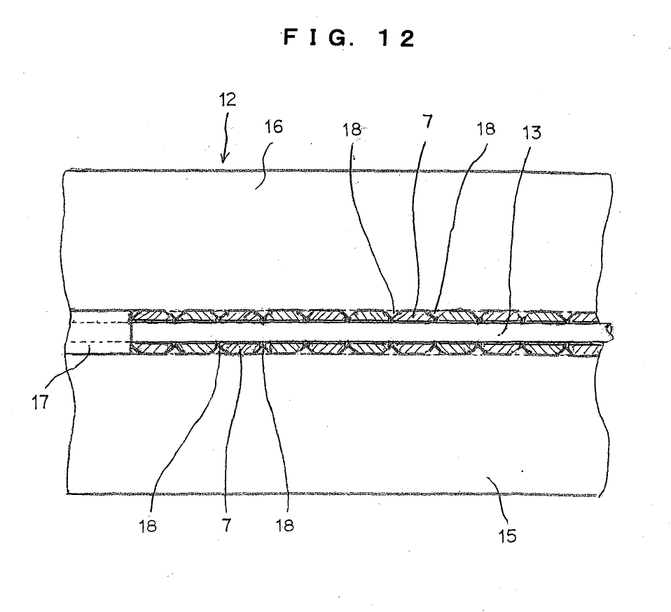

By using a transparent acrylic resin plate for the transparent plate 15 as the lower plate (rear plate) in the both surfaces of the arranged groups of the beads 7 like for the transparent plate 16, the surface of the bead picture 12 in FIG. 8 appears on one lateral surface, as well as a bead picture 12′ appears in symmetrical with the surface of the bead picture 12 on the other lateral surface as shown in FIG. 11 to obtain a bead picture that enables to visually observe one picture from both surface and rearface symmetrically.

By the way, during development of the present invention, as the size of the bead picture increased to make the support rod longer, it confronted a problem that the picture plane suffered from distortion or disturbance due to the weight at the central portion.

For solving the problem, as a result of tests and studies, the following dissolving means has been attained.

That is, a number of bead group units 14 are disposed in rows or columns to the transparent plate 15 formed of a transparent acrylic resin on the rear side disposed horizontally in the picture frame member to form a bead picture plane. Since gaps are formed between right and left and front and back beads 7 adjacent to each other on the bead picture plane, when a transparent resin solution that cures at a normal temperature or at an elevated temperature, preferably, a transparent acrylic resin formed of the same material as the front and rear transparent plates 15, 16 is spread on the bead picture surface, it flows into and stagnates in the gap between the beads 7.

As described above, the acrylic transparent plate 16 on the front side is superposed over the upper surface of the bead picture where the transparent resin is stagnated in the gap between the beads 7 and the front and rear transparent plates 15 and 16 are in press contact with each other, the transparent resin adhered to the gap between the beads or to the beads 7 cures in a state bonded integrally to the acrylic transparent plates 15, 16 on both surfaces to form a bead supporting and receiving portion 18.

As a result, each of the beads 7 is positionally fixed being supported on the bead supporting and receiving portion 18 formed integrally with the acrylic transparent plates 15, 16 by way of the gap. Therefore, since heavy pressure of the beads 7 no more exerts on the support rod 13, the bead picture is free from disadvantages such as distortion, slack, and disturbance.

### INDUSTRIAL APPLICABILITY

A bead picture corresponding to images such as of an optional color photograph or picture can be completed by repeating simple manual operations along with the guidance of the digitalized color number arrangement table, to obtain a colorful bead picture rich in decorative and creative sense.

Since identical bead pictures can be manufactured repetitively and mass production therefor is also possible, it can be utilized not only to creative decorative stationary articles but also as building materials of high decorative and additional values such as stained glass or window glass.

1. A bead picture formed by digitalizing image data of an original recorded in a computer on a pixel unit to subtractive color image data allotted to a predetermined number of colors of beads on an image pixel unit, arranging and supporting a number of material beads of corresponding colors to a transparent plate in a picture frame based on the indication of a digitalized color number arrangement for the subtractive color image data which is image-displayed corresponding to the original, and integrally forming a bead supporting and receiving portion formed by curing a transparent resin solution with the surface of the transparent plate in a gap between a bead group arranged on the transparent plate.

2. A bead picture according to claim 1, wherein the plurality of beads comprise each a bead sphere of an identical shape having a through hole in the axial direction, a plurality of bead spheres of color numbers corresponding to the color number arrangement table are formed into a plurality of bead group units externally fitted being linked over longitudinal or lateral guide rods, and guide rods for respective bead group units are arranged in rows and columns and supported on a picture frame member.

3. A bead picture according to claim 1 or 2, wherein both front and rear faces of the bead picture in which the beads are arranged and supported are sandwiched between transparent plates such that pictures of symmetrical picture planes can be observed visually from both surfaces.

4. (canceled)

5. (canceled)

6. A method of manufacturing a bead picture including:
recording the image data of an original on a pixel unit in a computer, applying image processing to the recorded image data of the computer to a subtractive color image data of a predetermined number of colors of beads based on the size of a bead picture to be prepared and the size of a bead sphere to be used, digitalizing the subtractive color image data to color numbers on an image pixel unit, indicating the color numbers of the digitalized subtractive color image data on the color number arraignment table of a predetermined size corresponding to the original, and arranging a plurality of beads corresponding to respective color numbers to a rear transparent plate in a picture frame based on the arrangement of the indicated color numbers, casting and stagnating a transparent resin solution that cures at a normal temperature or at an elevated temperature in a gap between beads on the bead picture plane, superposing a front transparent plate over the upper surface thereof, and integrally curing the transparent resin stagnated in the gap between the beads with the surfaces of the front and rear face transparent plates, thereby forming a bead supporting and receiving portion.
